(19) United States
(12) Patent Application Publication
(10) Pub. No.: US 2026/0135262 A1
(43) Pub. Date: May 14, 2026

(54) ENERGY STORAGE APPARATUS

(71) Applicant: GS Yuasa International Ltd., Kyoto-shi (JP)

(72) Inventors: Masayoshi OGUSHI, Kyoto-shi (JP); Kenichi FUKAYAMA, Kyoto-shi (JP); Ryota MOCHIZUKI, Kyoto-shi (JP)

(21) Appl. No.: 19/444,366

(22) Filed: Jan. 9, 2026

Related U.S. Application Data
(63) Continuation of application No. PCT/JP2024/025402, filed on Jul. 16, 2024.

(30) Foreign Application Priority Data
Jul. 20, 2023 (JP) 2023-118045

(51) Int. Cl. H01M 50/503; H01G 11/10; H01M 50/209

(52) U.S. Cl. CPC H01M 50/503; H01M 50/209; H01G 11/10

(57) ABSTRACT

An energy storage apparatus includes a first energy storage device, a second energy storage device, and a bus bar, in which the first energy storage device and the second energy storage device are arranged side by side in a first direction, the first energy storage device includes a first terminal arranged in a second direction intersecting the first direction, the second energy storage device includes a second terminal arranged in the second direction, the bus bar includes a first joint portion and a second joint portion joined to the first terminal, and a third joint portion joined to the second terminal, the first joint portion and the second joint portion are separated in a third direction intersecting the first direction and the second direction, and the third joint portion is in a central portion of the bus bar in the third direction.

### CROSS REFERENCE TO RELATED APPLICATIONS

This application claims the benefit of priority to Japanese Patent Application No. 2023-118045 filed on Jul. 20, 2023 and is a Continuation Application of PCT Application No. PCT/JP2024/025402 filed on Jul. 16, 2024. The entire contents of each application are hereby incorporated herein by reference.

### BACKGROUND OF THE INVENTION

### 1. Field of the Invention

The present invention relates to energy storage apparatuses.

### 2. Description of the Related Art

JP-A-2018-206638 discloses a battery module including a plurality of batteries and a plurality of bus bars connecting the plurality of batteries. Each bus bar is made of a planar plate-shaped conductive member, and peripheries of both ends thereof are connected to electrode terminals of adjacent batteries by welding.

### SUMMARY OF THE INVENTION

In the bus bar included in the above conventional battery module, the peripheries of the two ends welded to upper surfaces of the two electrode terminals are formed in the same shape. Therefore, for example, when there is an element (convex portion or the like) that may hinder the joining with the bus bar on the surface of one of the two electrode terminals facing the bus bar, there is a possibility that the bus bar and the one electrode terminal cannot be favorably joined. This causes a decrease in reliability of an energy storage apparatus.

Example embodiments of the present invention provide energy storage apparatuses each with improved reliability.

An energy storage apparatus according to an example embodiment of the present invention includes a first energy storage device, a second energy storage device, and a bus bar, in which the first energy storage device and the second energy storage device are arranged side by side in a first direction, the first energy storage device includes a first terminal arranged in a second direction intersecting the first direction, the second energy storage device includes a second terminal arranged in the second direction, the bus bar includes a first joint portion and a second joint portion joined to the first terminal, and a third joint portion joined to the second terminal, the first joint portion and the second joint portion are separated in a third direction intersecting the first direction and the second direction, and the third joint portion is in a central portion of the bus bar in the third direction.

According to example embodiments of the present invention, it is possible to provide energy storage apparatuses with improved reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration of an energy storage apparatus according to an example embodiment of the present invention.

FIG. 2 is an exploded perspective view of a bus bar unit according to an example embodiment of the present invention.

FIG. 3 is a perspective view of a bus bar and two energy storage devices according to an example embodiment of the present invention.

FIG. 4 is an enlarged perspective view illustrating a configuration of a bus bar and its periphery according to an example embodiment of the present invention.

FIG. 5 is a plan view illustrating a configuration of a bus bar and its periphery according to an example embodiment of the present invention.

FIG. 6 is a cross-sectional view illustrating a configuration of a bus bar and its periphery according to an example embodiment of the present invention.

FIG. 7 is a plan view illustrating a configuration of a bus bar and its periphery according to a modification example of an example embodiment of the present invention.

### DETAILED DESCRIPTION OF THE EXAMPLE EMBODIMENTS

(1) An energy storage apparatus according to an example embodiment of the present invention includes a first energy storage device, a second energy storage device, and a bus bar, in which the first energy storage device and the second energy storage device are arranged side by side in a first direction, the first energy storage device includes a first terminal arranged in a second direction intersecting the first direction, the second energy storage device includes a second terminal arranged in the second direction, the bus bar includes a first joint portion and a second joint portion joined to the first terminal, and a third joint portion joined to the second terminal, the first joint portion and the second joint portion are separated in a third direction intersecting the first direction and the second direction, and the third joint portion is in a central portion of the bus bar in the third direction.

According to the energy storage apparatus described in (1), when the first terminal has a portion that may hinder the joining with the bus bar, the bus bar can be joined to the first terminal at at least two places (first and second joint portions) while avoiding the portion. Therefore, the terminals (first terminal and second terminal) of the two energy storage devices (first energy storage device and second energy storage device) are favorably joined to the bus bar. Accordingly, the energy storage apparatus according to this example embodiment is an energy storage apparatus with improved reliability.

(2) In the energy storage apparatus described in (1), the bus bar may include a first opening portion, and the first opening portion may be between the first joint portion and the second joint portion in the third direction.

According to the energy storage apparatus described in (2), the bus bar can be joined to the first terminal while more reliably avoiding, for example, interference between a projecting portion (convex portion) in the first terminal and the bus bar by the first opening portion. Specifically, the bus bar can be joined to the first terminal at two places (first and second joint portions) between which the first opening portion is interposed in the third direction.

(3) In the energy storage apparatus described in (2), the bus bar may include a first joining plate portion including the first joint portion, and a second joining plate including the second joint portion, the second joining plate portion being separated from the first joining plate portion in the third direction, and the first opening portion may be a gap between the first joining plate portion and the second joining plate portion.

According to the energy storage apparatus described in (3), the gap between the two plate-shaped portions (first and second joining plate portions) is included as the first opening portion in the bus bar. Accordingly, it is possible to efficiently manufacture the bus bar including the first opening portion.

(4) In the energy storage apparatus described in any one of (1) to (3), when viewed in the second direction, at least a portion of the third joint portion may be aligned with a region between the first joint portion and the second joint portion in the first direction.

According to the energy storage apparatus described in (4), lengths of conductive paths respectively connecting the first joint portion and the second joint portion, which are separated in the third direction with the first opening portion interposed therebetween, and the third joint portion can be easily made the same. This is advantageous, for example, for improving the conduction efficiency between the two energy storage devices.

(5) In the energy storage apparatus described in any one of (1) to (4), the bus bar may include a first terminal connecting portion including the first joint portion and the second joint portion, a second terminal connecting portion including the third joint portion, and an intermediate connecting portion connecting the first terminal connecting portion and the second terminal connecting portion, the first terminal connecting portion may be located on one side of the second terminal connecting portion in the first direction, the intermediate connecting portion may be connected to an end of the first terminal connecting portion on the other side in the first direction and connected to an end of the second terminal connecting portion on the other side in the first direction.

According to the energy storage apparatus described in (5), the intermediate connecting portion extends from the end of the second terminal connecting portion on the other side in the first direction, and is connected to the first terminal connecting portion across, in the first direction, a space in the second direction with respect to the second terminal connecting portion. Thus, positional displacement of one of the first energy storage device and the second energy storage device with respect to the other of the first energy storage device and the second energy storage device is efficiently absorbed by the intermediate connecting portion.

(6) In the energy storage apparatus described in (5), the intermediate connecting portion may include a second opening portion at a position facing the third joint portion in the second direction.

According to the energy storage apparatus described in (6), work (for example, welding) for forming the third joint portion can be performed through the second opening portion. Thus, the bus bar and the second terminal can be joined more efficiently.

(7) In the energy storage apparatus described in any one of (1) to (6), the third joint portion may include a fourth joint portion and a fifth joint portion, and the fourth joint portion and the fifth joint portion may be located separately in the third direction.

According to the energy storage apparatus described in (7), the joint portions between the second terminal and the bus bar are separated in the third direction. Thus, the length of the conductive path connecting the first joint portion and the third joint portion and the length of the conductive path connecting the second joint portion and the third joint portion can be made substantially the same, and the length can be made relatively short. This is advantageous, for example, for improving the conduction efficiency between the two energy storage devices.

Hereinafter, energy storage apparatuses according to example embodiments (including modification examples thereof) of the present invention will be described with reference to the drawings. The example embodiments described below are comprehensive or specific examples. Numerical values, shapes, materials, components, arrangement positions and connection modes of the components, manufacturing processes, the order of the manufacturing processes, and the like illustrated in the following example embodiment are merely examples, and are not intended to limit the present invention. In the drawings, dimensions and the like are not strictly illustrated. In the drawings, identical or similar components are denoted by identical reference numerals.

In the following description and drawings, an arranging direction of a pair of terminals included in an energy storage device or a facing direction of a pair of short side surfaces in a container of the energy storage device is defined as an X-axis direction. A facing direction of a pair of long side surfaces in the container of the energy storage device, a thickness direction (flat direction) of the container of the energy storage device, or an arranging direction of a plurality of the energy storage devices included in an energy storage unit is defined as a Y-axis direction. A projecting direction of the terminal of the energy storage device, an arranging direction of a container body and a lid plate of the energy storage device, an arranging direction of the energy storage unit and the bus bar unit, or a vertical direction is defined as a Z-axis direction. The X-axis direction, the Y-axis direction, and the Z-axis direction are directions intersecting (orthogonal in the present example embodiment) each other. Although the Z-axis direction may not be the vertical direction depending on the usage mode, the Z-axis direction will be described below as the vertical direction for convenience of description.

In the following description, an X-axis positive direction indicates an arrow direction of the X axis, and an X-axis negative direction indicates a direction opposite to the X-axis positive direction. Simply referring to the X-axis direction refers to either or both of the X-axis positive direction and the X-axis negative direction. One side and the other side in the X-axis direction refer to one and the other of the X-axis positive direction and the X-axis negative direction. The same applies to the Y-axis direction and the Z-axis direction. Expressions indicating relative directions or postures, such as parallel and orthogonal, may include other directions or postures in a strict sense. For example, two directions being parallel not only means that the two directions are completely parallel, but also means that the two directions are substantially parallel, that is, include a difference of, for example, about several percent. In the following description, the expression “insulation” means “electrical insulation”. An insulating material is preferably formed from a material having a volume resistivity of 1×10¹⁰ Ωm or more.

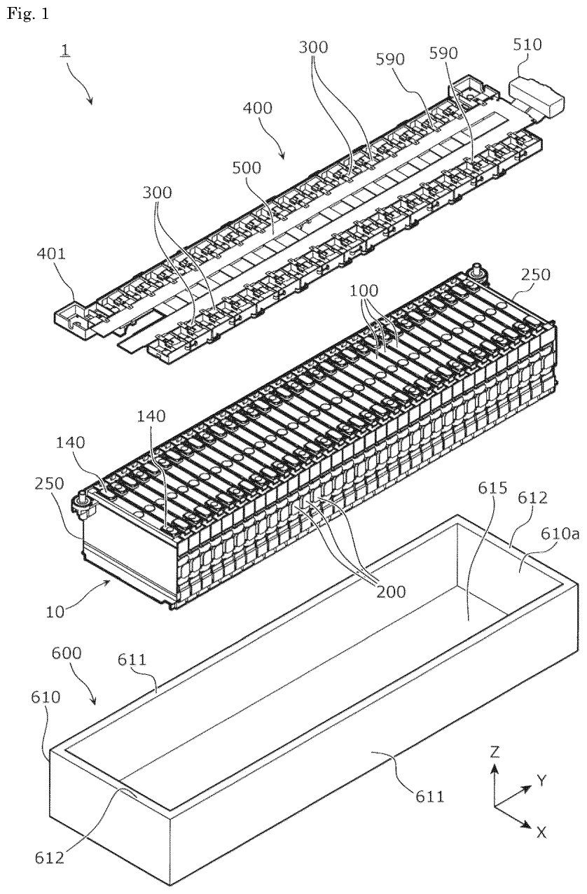

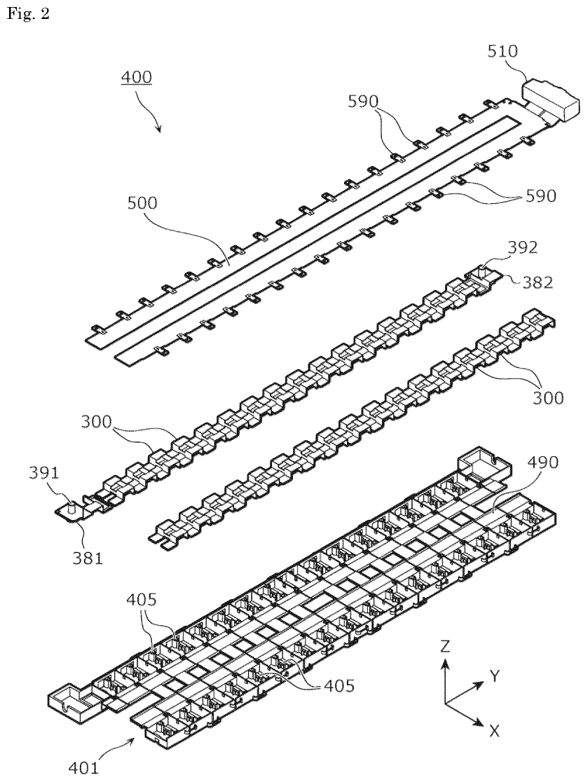

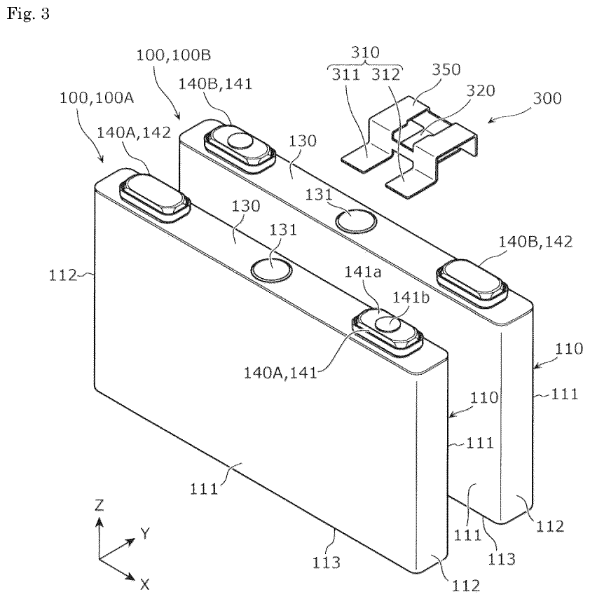

FIG. 1 is a perspective view illustrating a configuration of an energy storage apparatus 1 according to an example embodiment. FIG. 1 illustrates a state where an energy storage unit 10 and a bus bar unit 400 are taken out from a case body 610. FIG. 2 is an exploded perspective view of the bus bar unit 400 according to the present example embodiment. FIG. 3 is a perspective view of a bus bar 300 and two energy storage devices 100 according to the present example embodiment. The two energy storage devices 100 illustrated in FIG. 3 are two energy storage devices 100 adjacent to each other in the Y-axis direction. When these two energy storage devices 100 are described in a distinguished manner, the energy storage device 100 in the Y-axis negative direction is referred to as a first energy storage device 100A, and the energy storage device 100 in the Y-axis positive direction is referred to as a second energy storage device 100B. The first energy storage device 100A and the second energy storage device 100B are two energy storage devices 100 adjacent to each other in the Y-axis direction arbitrarily selected from a plurality of energy storage devices 100 (see FIG. 1) included in the energy storage apparatus 1. The Y-axis direction is an example of a first direction. In the drawings (FIGS. 3 to 7) of FIG. 3 and subsequent figures, illustration of a case 600, spacers 200 and 250, and the bus bar unit 400 illustrated in FIG. 1 is omitted.

The energy storage apparatus 1 is an apparatus that can be charged with electricity from the outside and discharge electricity to the outside. The energy storage apparatus 1 is, for example, a battery module (assembled battery) used for power storage application, power supply application, or the like. Specifically, the energy storage apparatus 1 is used as, for example, a battery for driving or starting an engine of a moving body such as an automobile, a motorcycle, a watercraft, a ship, a snowmobile, an agricultural machine, a construction machine, an automatic guided vehicle (AGV), or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, etc.) automobile. Examples of the railway vehicle for an electric railway include a train, a monorail, a linear motor car, and a hybrid train including both a diesel engine and an electric motor. In addition, the energy storage apparatus 1 can also be used as a stationary battery or the like used for home use, business use, or the like.

As illustrated in FIG. 1, the energy storage apparatus 1 includes the energy storage unit 10, the bus bar unit 400, and a case 600 that accommodates the energy storage unit 10. In addition to the above components, the energy storage apparatus 1 may include electric equipment such as a circuit board and a relay that monitor or control a charge state, a discharge state, and the like of the energy storage unit 10.

In the present example embodiment, the energy storage unit 10 is a battery module including the plurality of energy storage devices 100. Specifically, the energy storage unit 10 includes the plurality of (for example, thirty four in the present example embodiment) energy storage devices 100, the spacer 200 between two energy storage devices 100 adjacent to each other in the Y-axis direction, and spacers 250 respectively disposed on outer sides of the energy storage devices 100 at both ends in the Y-axis direction. The spacer 200 is also called, for example, an “inter-cell spacer”. The spacer 250 is also called, for example, an “end spacer”. In the present example embodiment, the spacers 200 and 250 also function as cell holders that hold one or more energy storage devices 100 disposed along the spacer 200 or 250.

The energy storage unit 10 has a substantially rectangular parallelepiped shape elongated in the Y-axis direction with the plurality of energy storage devices 100, the plurality of spacers 200, and the pair of spacers 250 arranged in the Y-axis direction. The plurality of energy storage devices 100 included in the energy storage unit 10 are electrically connected to each other by a plurality of the bus bars 300.

In the present example embodiment, the energy storage unit 10 is a non-binding type module that does not include a binding member (end plate, side plate, and the like) that binds the plurality of energy storage devices 100 in the Y-axis direction. However, the energy storage unit 10 may include a binding member that binds the plurality of energy storage devices 100 and the plurality of spacers 200 and 250 in the Y-axis direction. The energy storage unit 10 may not include the spacers 200 and 250. For example, when an insulating film is located on each of the plurality of energy storage devices 100, the energy storage device 100 and another member (another energy storage device 100 or the like) adjacent to the energy storage device 100 are electrically insulated from each other at least by the insulating film disposed on the energy storage device 100.

The energy storage device 100 is a secondary battery (battery cell), more specifically a nonaqueous electrolyte secondary battery such as a lithium ion secondary battery. As illustrated in FIG. 3, the energy storage device 100 includes a container 110 having a flat rectangular parallelepiped shape (prismatic shape). An electrode assembly, a current collector, an electrolyte solution, and the like (not illustrated) are accommodated in the container 110. As the electrode assembly, for example, a winding-type electrode assembly formed by winding a plate and a separator is employed. As the electrode assembly, a layered (stacked) electrode assembly formed by layering a plurality of flat-shaped plates, or an electrode assembly having a structure in which long belt-shaped plates are layered in a bellows shape by repeating mountain folding and valley folding may be adopted. As the electrolyte solution to be accommodated in the container 110, a kind of the electrolyte solution is not particularly limited as long as performance of the energy storage device 100 is not impaired, and various electrolyte solutions can be selected. The energy storage device 100 may be a secondary battery other than the nonaqueous electrolyte secondary battery, or may be a capacitor. The energy storage device 100 may be a primary battery. The energy storage device 100 may be a battery using a solid electrolyte. The energy storage device 100 may be a pouch type energy storage device. The shape of the energy storage device 100 is not limited to the above prismatic shape, and may be a polygonal columnar shape, a cylindrical shape, an elliptical columnar shape, an oval columnar shape or the like other than the above prismatic shape.

As illustrated in FIG. 3, the container 110 is a rectangular parallelepiped case including a pair of long side surfaces 111, a pair of short side surfaces 112, and a bottom surface 113, which are formed of the container body, and a terminal arrangement surface 130 formed of a lid plate. The rectangular parallelepiped referred to herein is a hexahedron in which all surfaces are rectangular or square. After the electrode assembly and the like are accommodated in the inside of the container body, the inside of the container 110 is sealed by welding or the like between the container body and the lid plate. The material of the container 110 is not particularly limited, but is preferably weldable metal such as stainless steel, aluminum, an aluminum alloy, iron, or a plated steel plate.

The energy storage device 100 includes a terminal 140 arranged in the Z-axis direction. The Z-axis direction is an example of a second direction. The terminal 140 is electrically connected to the electrode assembly accommodated in the container 110. More specifically, a pair of the terminals 140 is disposed so as to project in the Z-axis positive direction from the terminal arrangement surface 130 of the container 110. The terminal arrangement surface 130 is further provided with a gas release valve 131. One of the pair of terminals 140 is electrically connected to a positive electrode of the electrode assembly, and the other is electrically connected to a negative electrode of the electrode assembly. Hereinafter, when the terminal 140 of the negative electrode and the terminal 140 of the positive electrode are distinguished from each other, the terminal 140 of the negative electrode is referred to as a negative electrode terminal 141, and the terminal 140 of the positive electrode is referred to as a positive electrode terminal 142.

The negative electrode terminal 141 includes a terminal body 141a made of aluminum or an aluminum alloy, and a shaft body made of copper or a copper alloy. The shaft body is joined to the terminal body 141a in a state of penetrating the terminal body 141a, and an end of the shaft body slightly projects from an upper surface (surface facing in the Z-axis positive direction, the same applies hereinafter) of the terminal body 141a. Thus, the terminal body 141a is formed with a terminal convex portion 141b formed by the end (see FIG. 3). The positive electrode terminal 142 is made of aluminum or an aluminum alloy, and has a flat upper surface.

In the present example embodiment, as illustrated in FIG. 3, the terminal 140 included in the first energy storage device 100A is referred to as a first terminal 140A, and the terminal 140 included in the second energy storage device 100B is referred to as a second terminal 140B. That is, the first energy storage device 100A includes the negative electrode terminal 141 and the positive electrode terminal 142, which are two first terminals 140A, and the second energy storage device 100B includes the negative electrode terminal 141 and the positive electrode terminal 142, which are two second terminals 140B. When the first energy storage device 100A and the second energy storage device 100B are arranged in the Y-axis direction, the first terminal 140A and the second terminal 140B are arranged in the Y-axis direction. In this state, one of the first terminal 140A and the second terminal 140B is the negative electrode terminal 141, and the other is the positive electrode terminal 142. FIG. 3 illustrates that the negative electrode terminal 141, which is the first terminal 140A, and the positive electrode terminal 142, which is the second terminal 140B, are connected by the bus bar 300.

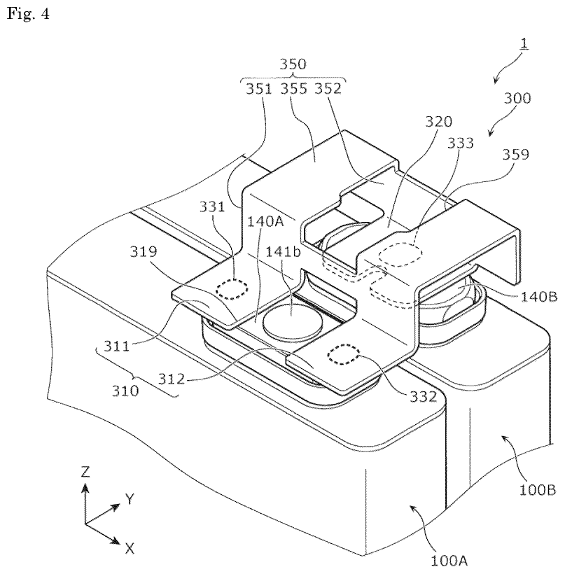

As illustrated in FIG. 3, the bus bar 300 electrically and mechanically connecting the first terminal 140A and the second terminal 140B includes a first terminal connecting portion 310, a second terminal connecting portion 320, and an intermediate connecting portion 350. Each of the first terminal connecting portion 310 and the second terminal connecting portion 320 is a plate-shaped portion joined to the upper surface of the terminal 140. The intermediate connecting portion 350 is a plate-shaped portion that connects the first terminal connecting portion 310 and the second terminal connecting portion 320. In the present example embodiment, the intermediate connecting portion 350, the first terminal connecting portion 310, and the second terminal connecting portion 320 are integrally provided. The configuration of the bus bar 300 and its periphery will be described later with reference to FIGS. 4 to 6.

The case 600 is a container having a substantially rectangular parallelepiped shape (box shape) and accommodating the energy storage unit 10. The case 600 is disposed outward the energy storage unit 10 and protects the energy storage unit 10 from an impact or the like. The case 600 is formed of a metal member such as aluminum, an aluminum alloy, stainless steel, iron, or a plated steel plate. In the present example embodiment, the case 600 is formed by die-casting aluminum (aluminum die-casting). Instead of the case 600, a case formed of an insulating member such as a resin material may be adopted as a case for accommodating the energy storage unit 10.

As illustrated in FIG. 1, the case 600 includes the case body 610. The case body 610 is a housing in which an opening 610a of a size into which the energy storage unit 10 can be inserted is formed in the Z-axis positive direction. The case body 610 includes a case side wall portion 611 facing the energy storage unit 10 in the X-axis direction, a case side wall portion 612 facing the energy storage unit 10 in the Y-axis direction, and a case bottom wall portion 615 that supports the energy storage unit 10 from the Z-axis negative direction. The X-axis direction is an example of a third direction. The case 600 may further include a lid (not illustrated) that closes the opening 610a of the case body 610.

The bus bar unit 400 includes the plurality of bus bars 300, the bus bar holder 401 that holds the plurality of bus bars 300, and a wiring board 500. The bus bar unit 400 is disposed to face the energy storage unit 10 in the Z-axis direction. The bus bar holder 401 is a member formed of an insulating material such as resin, and includes a plurality of bus bar accommodating portions 405 that accommodates the plurality of bus bars 300. The bus bar accommodating portion 405 is a portion formed in a box shape, and accommodates and holds the bus bar 300 in a state where a lower surface (surface in the Z-axis negative direction) of the bus bar 300 is exposed. In the present example embodiment, as illustrated in FIGS. 1 to 3, two energy storage devices 100 adjacent to each other in the Y-axis direction are connected in series by the bus bar 300. That is, the plurality of energy storage devices 100 included in the energy storage unit 10 are connected in series by the plurality of bus bars 300. Each of the plurality of bus bars 300 is held in the bus bar accommodating portion 405 at a position corresponding to the bus bar 300. In the present example embodiment, a bus bar 382 is joined to the negative electrode terminal 141 of the energy storage device 100 at the end of the energy storage unit 10 in the Y-axis positive direction, and a bus bar 381 is joined to the positive electrode terminal 142 of the energy storage device 100 at the end of the energy storage unit 10 in the Y-axis negative direction. The bus bars 382 and 381 are also held by the bus bar holder 401.

As illustrated in FIG. 2, the bus bar 382 is provided with a negative electrode total terminal 392 projecting in the Z-axis positive direction, and the bus bar 381 is provided with a positive electrode total terminal 391 projecting in the Z-axis positive direction. The negative electrode total terminal 392 and the positive electrode total terminal 391 are connected to another device by a cable or the like, whereby the energy storage apparatus 1 supplies power to the device. In place of or in addition to the power supply to the device, the energy storage apparatus 1 may be charged with power supplied from the device. Each of the negative electrode total terminal 392 and the positive electrode total terminal 391 may be used as an external terminal by projecting from the inside of the case 600 to the outside.

As illustrated in FIG. 2, the bus bar holder 401 includes, at a central portion in the X-axis direction, a board support portion 490 that supports the wiring board 500. The wiring board 500 supported by the board support portion 490 includes a board formed of an insulating material and wiring of a conductor formed on the board. A plurality of conductive members 590 is connected to the wiring board 500, and each of the plurality of conductive members 590 is connected to one bus bar 300, 381, or 382. A connector 510 is connected to an end of the wiring board 500 in the Y-axis positive direction. For example, a control device that controls charge-discharge of the energy storage apparatus 1 is connected to the connector 510. The control device detects a voltage of each of the plurality of energy storage devices 100 via the plurality of conductive members 590 and the wiring board 500, and controls charge-discharge of the plurality of energy storage devices 100 based on a detection result. That is, in the present example embodiment, the conductive member 590 is a terminal (detection terminal) for voltage detection.

Next, the configuration of the bus bar 300 and its periphery will be described with reference to FIGS. 4 to 6 in addition to FIGS. 1 to 3 described above. Hereinafter, with attention being paid to one bus bar 300 that electrically connects two energy storage devices 100 (the first energy storage device 100A and the second energy storage device 100B) adjacent to each other, the configuration of the bus bar 300 and its periphery will be described.

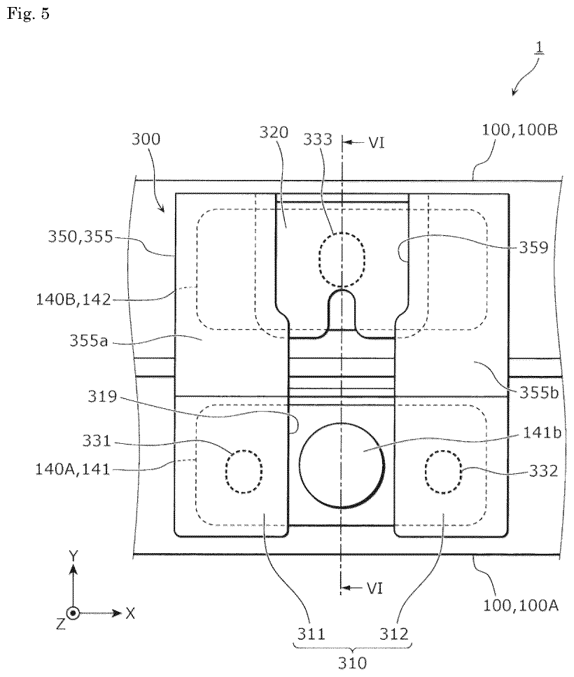

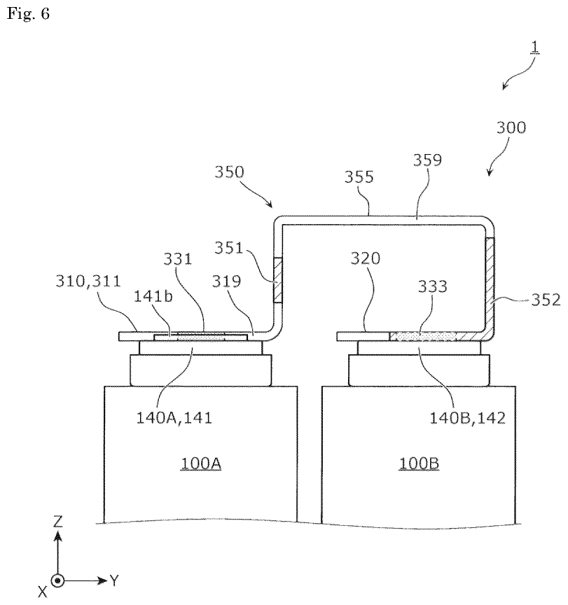

FIG. 4 is an enlarged perspective view illustrating the configuration of the bus bar 300 and its periphery according to the present example embodiment. FIG. 5 is a plan view (as viewed in the Z-axis positive direction) illustrating the configuration of the bus bar 300 and its periphery according to the present example embodiment. In FIGS. 4 and 5, each of a first joint portion 331, a second joint portion 332, and a third joint portion 333 is schematically represented by an annular dotted line. FIG. 6 is a cross-sectional view illustrating the configuration of the bus bar 300 and its periphery according to the present example embodiment. FIG. 6 simply illustrates a cross section taken along line VI-VI in FIG. 5. FIG. 6 simply illustrates not a cross section but side surfaces of the two energy storage devices 100. In FIG. 6, an approximate arrangement range of each of the first joint portion 331 and the third joint portion 333 in the X-axis direction is represented by a dotted region.

As illustrated in FIGS. 4 to 6, the bus bar 300 is joined to the first terminal 140A of the first energy storage device 100A and the second terminal 140B of the second energy storage device 100B. Specifically, the bus bar 300 includes the first joint portion 331 and the second joint portion 332 joined to the first terminal 140A, and the third joint portion 333 joined to the second terminal 140B. The first joint portion 331 and the second joint portion 332 are separated in the X-axis direction.

The bus bar 300 is joined to each of the first terminal 140A and the second terminal 140B by laser welding, for example. That is, each of the first joint portion 331, the second joint portion 332, and the third joint portion 333 is formed by, for example, laser welding. Each of these joint portions (the first joint portion 331, the second joint portion 332, and the third joint portion 333, hereinafter the same) may be formed in an annular shape as illustrated in FIGS. 4 and 5, or may be formed in a partially missing annular shape (a C-shape, a G-shape, or the like). Each of these joint portions does not need to be formed in an annular shape, and may be formed in a linear shape or a linear shape (V-shape, U-shape, or the like) including a curved or bent portion at least in part. Each of these joint portions does not need to be formed in a linear shape, and may be formed in a continuous planar shape within a predetermined range in plan view.

In the present example embodiment, more specifically, the bus bar 300 includes the first terminal connecting portion 310 joined to the first terminal 140A, the second terminal connecting portion 320 joined to the second terminal 140B, and the intermediate connecting portion 350 connecting the first terminal connecting portion 310 and the second terminal connecting portion 320. That is, the first terminal connecting portion 310 includes the first joint portion 331 and the second joint portion 332, and the second terminal connecting portion 320 includes the third joint portion 333.

In the present example embodiment, as illustrated in FIGS. 4 and 5, the first terminal connecting portion 310 includes two plate-shaped portions disposed apart from each other in the X-axis direction. Specifically, as illustrated in FIGS. 3 to 5, the first terminal connecting portion 310 includes a first joining plate portion 311 and a second joining plate portion 312. The first joint portion 331 is formed in the first joining plate portion 311, and the second joint portion 332 is formed in the second joining plate portion 312. In the present example embodiment, as illustrated in FIGS. 4 and 5, a first opening portion 319 is formed by a gap between the first joining plate portion 311 and the second joining plate portion 312, and the terminal convex portion 141b of the first terminal 140A is arranged in the first opening portion 319.

That is, in the first terminal 140A, which is the negative electrode terminal 141 in the present example embodiment, the terminal convex portion 141b is formed by the end of the shaft portion projecting from the upper surface of the terminal body 141a (see FIGS. 3, 4, and 6). Accordingly, in order to favorably join the bus bar 300 and the upper surface of the terminal body 141a, it is preferable to avoid interference between the bus bar 300 and the terminal convex portion 141b.

More specifically, the upper surface of the terminal body 141a and an upper end surface of the terminal convex portion 141b are different in position in the Z-axis direction. Therefore, for example, it is not easy to form the shape of the first terminal connecting portion 310 of the bus bar 300 into a shape that is in surface contact with both the upper surface of the terminal body 141a and the upper end surface of the terminal convex portion 141b with high accuracy. Further, the material of the shaft portion forming the terminal convex portion 141b is, for example, a copper alloy, and the material forming the terminal body 141a is, for example, an aluminum alloy. Accordingly, there is also a problem that it is relatively difficult to join the bus bar 300 formed of, for example, an aluminum alloy and the terminal convex portion 141b by welding.

Therefore, in the present example embodiment, the portions (the first joint portion 331 and the second joint portion 332) of the bus bar 300 joined to the first terminal 140A are separated in the X-axis direction. That is, by disposing the terminal convex portion 141b of the first terminal 140A between the first joint portion 331 and the second joint portion 332, the interference between the bus bar 300 and the terminal convex portion 141b can be avoided.

Further, as illustrated in FIG. 5, the third joint portion 333, which is a portion of the bus bar 300 joined to the second terminal 140B, is positioned at the central portion of the bus bar 300 in the X-axis direction. More specifically, the center of the third joint portion 333 in the X-axis direction is included in the central portion of the bus bar 300 in the X-axis direction. In the present example embodiment, the central portion of the bus bar 300 in the X-axis direction is, for example, a range including the center line (coinciding with line VI-VI in FIG. 5) of the bus bar 300 in the X-axis direction, that is, a range of ⅓ of the maximum width of the bus bar 300 in the X-axis direction. In the present example embodiment, as illustrated in FIG. 5, the second terminal connecting portion 320 including the third joint portion 333 has a symmetrical shape with respect to the center line (line VI-VI) of the bus bar 300 in the X-axis direction. Accordingly, it can also be described that the third joint portion 333 is positioned at the central portion of the second terminal connecting portion 320 in the X-axis direction. That is, the first terminal connecting portion 310 of the bus bar 300 according to the present example embodiment is joined to the first terminal 140A at two joint portions (the first joint portion 331 and the second joint portion 332) separated in the X-axis direction. Further, a region between the first joint portion 331 and the second joint portion 332 in the X-axis direction and at least a portion of the third joint portion 333 are aligned in the Y-axis direction.

As described above, the energy storage apparatus 1 according to the present example embodiment includes the first energy storage device 100A, the second energy storage device 100B, and the bus bar 300. The first energy storage device 100A and the second energy storage device 100B are arranged side by side in the Y-axis direction. The first energy storage device 100A includes the first terminal 140A arranged in the Z-axis direction intersecting the Y-axis direction. The second energy storage device 100B includes the second terminal 140B arranged in the Z-axis direction. The bus bar 300 includes the first joint portion 331 and the second joint portion 332 joined to the first terminal 140A, and the third joint portion 333 joined to the second terminal 140B. The first joint portion 331 and the second joint portion 332 are separated in the X-axis direction intersecting the Y-axis direction and the Z-axis direction. The third joint portion 333 is in the central portion of the bus bar 300 in the X-axis direction.

That is, the bus bar 300 according to the present example embodiment includes, as a joint portion with the first terminal 140A, the first joint portion 331 and the second joint portion 332 separated in the X-axis direction. Accordingly, the bus bar 300 can be joined to the first terminal 140A at least at two places (the first joint portion 331 and the second joint portion 332) while avoiding a portion (the terminal convex portion 141b in the present example embodiment) of the first terminal 140A that may hinder the joining with the bus bar 300. Therefore, the terminals 140 (the first terminal 140A and the second terminal 140B) of the two energy storage devices 100 (the first energy storage device 100A and the second energy storage device 100B) and the bus bar 300 are favorably joined to each other. Accordingly, the energy storage apparatus 1 according to the aspect is an energy storage apparatus with improved reliability.

Further, the third joint portion 333, which is a joint portion of the bus bar 300 with the second terminal 140B, is positioned at the central portion of the bus bar 300 in the X-axis direction. Accordingly, the difference between the length of the conductive path connecting the first joint portion 331 and the third joint portion 333 and the length of the conductive path connecting the second joint portion 332 and the third joint portion 333 can be reduced. Thus, the conduction efficiency between the first energy storage device 100A and the second energy storage device 100B is improved, and as a result, discharge and charge of the energy storage apparatus 1 are efficiently performed. This also contributes to improvement of reliability of the energy storage apparatus 1.

More specifically, as illustrated in FIGS. 4 and 5, the bus bar 300 according to the present example embodiment includes the first opening portion 319. The first opening portion 319 is between the first joint portion 331 and the second joint portion 332 in the X-axis direction.

According to this configuration, the bus bar 300 can be joined to the first terminal 140A while more reliably avoiding the interference between the terminal convex portion 141b of the first terminal 140A and the bus bar 300 by the first opening portion 319. Specifically, the bus bar 300 can be joined to the first terminal 140A at two places (the first joint portion 331 and the second joint portion 332) between which the first opening portion 319 is interposed in the X-axis direction.

It is not essential for the bus bar 300 to include the first opening portion 319 between the first joint portion 331 and the second joint portion 332. For example, in place of the first opening portion 319, a recessed portion recessed in the Z-axis positive direction may be provided. That is, the first terminal connecting portion 310 may include a recessed portion between the first joint portion 331 and the second joint portion 332 and recessed in the Z-axis positive direction. Even in this case, since the recessed portion of the first terminal connecting portion 310 is present at a position facing the terminal convex portion 141b in the Z-axis direction, the bus bar 300 can be joined to the first terminal 140A while avoiding the interference between the bus bar 300 and the terminal convex portion 141b. However, from the viewpoint of, for example, more reliably avoiding the interference between the bus bar 300 and the terminal convex portion 141b, the bus bar 300 preferably includes, between the first joint portion 331 and the second joint portion 332, the first opening portion 319 penetrating the bus bar 300.

The size and shape of the first opening portion 319 in plan view do not need to be the size and shape illustrated in FIGS. 4 and 5. The size and shape of the first opening portion 319 may be any size and shape including the terminal convex portion 141b in plan view.

More specifically, the bus bar 300 includes the first joining plate portion 311 in which the first joint portion 331 is formed and the second joining plate portion 312 in which the second joint portion 332 is formed. The second joining plate portion 312 is disposed separately from the first joining plate portion 311 in the X-axis direction. The first opening portion 319 is a gap between the first joining plate portion 311 and the second joining plate portion 312.

As described above, in the present example embodiment, the gap (space) between the two plate-shaped portions (the first joining plate portion 311 and the second joining plate portion 312) is provided as the first opening portion 319 in the bus bar 300. Accordingly, the first opening portion 319 can be easily formed as compared with a case where, for example, a substantially circular through-hole matching the position, size, and shape of the terminal convex portion 141b is formed as the first opening portion 319 in the bus bar 300. Therefore, the bus bar 300 including the first opening portion 319 can be efficiently manufactured.

The positional relationship among the first joint portion 331, the second joint portion 332, and the third joint portion 333 in the present example embodiment will be described, for example, as follows. When viewed in the Z-axis direction, at least a portion of the third joint portion 333 is aligned with the region between the first joint portion 331 and the second joint portion 332 in the Y-axis direction. More specifically, in the present example embodiment, the first opening portion 319 is provided between the first joint portion 331 and the second joint portion 332, and the first opening portion 319 and at least a portion of the third joint portion 333 are aligned in the Y-axis direction.

According to this configuration, the lengths of the conductive paths respectively connecting the first joint portion 331 and the second joint portion 332, which are separated in the X-axis direction with the first opening portion 319 interposed therebetween, and the third joint portion 333 can be easily made the same. This is advantageous, for example, for improving the conduction efficiency between the first energy storage device 100A and the second energy storage device 100B.

Both the first joining plate portion 311 and the second joining plate portion 312 of the bus bar 300 are portions joined to the first terminal 140A, and are portions of the first terminal connecting portion 310 included in the bus bar 300. That is, as illustrated in FIGS. 4 to 6, the bus bar 300 includes the first terminal connecting portion 310 in which the first joint portion 331 and the second joint portion 332 are formed, the second terminal connecting portion 320 in which the third joint portion 333 is formed, and the intermediate connecting portion 350. The intermediate connecting portion 350 connects the first terminal connecting portion 310 and the second terminal connecting portion 320. The first terminal connecting portion 310 is located on one side (in the Y-axis negative direction in the present example embodiment) of the second terminal connecting portion 320 in the Y-axis direction. The intermediate connecting portion 350 is connected to an end of the first terminal connecting portion 310 on the other side in the Y-axis direction (the Y-axis positive direction in the present example embodiment), and is connected to an end of the second terminal connecting portion 320 on the other side in the Y-axis direction (the Y-axis positive direction in the present example embodiment). That is, the intermediate connecting portion 350 connects the end of the first terminal connecting portion 310 in the Y-axis positive direction and the end of the second terminal connecting portion 320 in the Y-axis positive direction.

As described above, in the bus bar 300 according to the present example embodiment, the intermediate connecting portion 350 extends from the end of the second terminal connecting portion 320 in the Y-axis positive direction, and is connected to the first terminal connecting portion 310 across, in the Y-axis direction, the space above the second terminal connecting portion 320 (in the Z-axis positive direction). In other words, the intermediate connecting portion 350 extends from the end of the first terminal connecting portion 310 in the Y-axis positive direction, and is connected to the second terminal connecting portion 320 across, in the Y-axis direction, a space above the second terminal connecting portion 320 (in the Z-axis positive direction). Thus, positional displacement of one of the first energy storage device 100A and the second energy storage device 100B with respect to the other of the first energy storage device 100A and the second energy storage device 100B is efficiently absorbed by the intermediate connecting portion 350.

More specifically, as illustrated in FIGS. 4 to 6, the intermediate connecting portion 350 included in the bus bar 300 includes a first intermediate portion 351, a second intermediate portion 352, and a third intermediate portion 355. The first intermediate portion 351 is connected to the end of the first terminal connecting portion 310 in the Y-axis positive direction and extends in the Z-axis positive direction. The second intermediate portion 352 is connected to the end of the second terminal connecting portion 320 in the Y-axis positive direction and extends in the Z-axis positive direction. Both the first intermediate portion 351 and the second intermediate portion 352 have a flat plate shape and are parallel to an XZ plane. The third intermediate portion 355 is connected to ends of the first intermediate portion 351 and the second intermediate portion 352 in the Z-axis positive direction. The third intermediate portion 355 has a flat plate shape and is parallel to an XY plane. As described above, in the bus bar 300 according to the present example embodiment, a portion including the intermediate connecting portion 350 and the second terminal connecting portion 320 is formed so as to have a square tubular shape.

The shape of the intermediate connecting portion 350 is not limited thereto. The shape of the intermediate connecting portion 350 is not particularly limited as long as it connects the first terminal connecting portion 310 and the second terminal connecting portion 320. For example, the intermediate connecting portion 350 may be a series of plate-shaped portions that connects the first terminal connecting portion 310 and the second terminal connecting portion 320 and is curved in the Z-axis direction as a whole. The intermediate connecting portion 350 may be a plate-shaped portion that connects the first terminal connecting portion 310 and the second terminal connecting portion 320 and in which only one place or three or more places are curved or bent when viewed in the X-axis direction. Further, the intermediate connecting portion 350 may be, for example, a flat plate-shaped portion that connects the ends of the first terminal connecting portion 310 and the second terminal connecting portion 320 facing each other in the Y axis direction. That is, it is not essential for the bus bar 300 to have a three-dimensional shape as illustrated in FIG. 4.

An opening portion is formed in the intermediate connecting portion 350 included in the bus bar 300 according to the present example embodiment. Specifically, the intermediate connecting portion 350 includes a second opening portion 359 at a position facing the third joint portion 333 in the Z-axis direction. More specifically, as illustrated in FIG. 5, the third intermediate portion 355 includes two portions (a third intermediate portion 355a and a third intermediate portion 355b) separated in the X-axis direction. The second opening portion 359 is a gap (space) between the third intermediate portion 355a and the third intermediate portion 355b in the intermediate connecting portion 350.

According to this configuration, work (for example, laser welding) for forming the third joint portion 333 can be performed through the second opening portion 359. Thus, the bus bar 300 and the second terminal 140B can be joined more efficiently.

The energy storage apparatus 1 according to the present example embodiment has been described mainly with respect to the configuration of the bus bar 300 and its periphery. However, the energy storage apparatus 1 may include a configuration of the bus bar 300 and its periphery different from those in FIGS. 2 to 6. Hereinafter, a modification example of the energy storage apparatus 1 will be described focusing on differences from the above example embodiment.

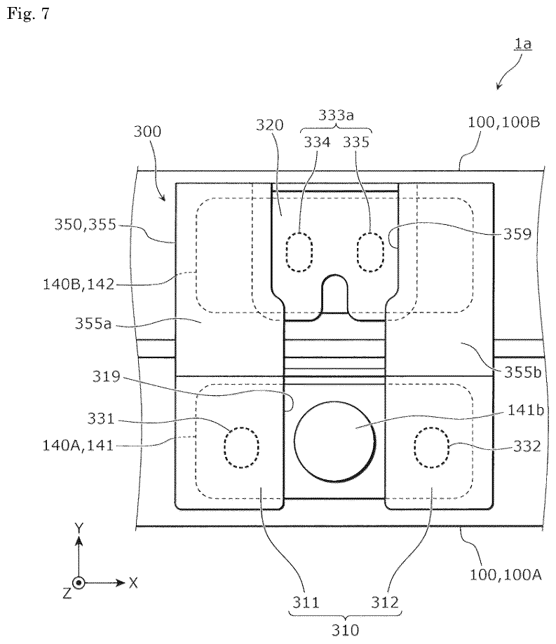

FIG. 7 is a plan view illustrating a configuration of the bus bar 300 and its periphery according to a modification example of an example embodiment. As illustrated in FIG. 7, an energy storage apparatus 1a according to the present modification example includes the bus bar 300 joined to the first terminal 140A of the first energy storage device 100A and the second terminal 140B of the second energy storage device 100B. The bus bar 300 includes the first joint portion 331 and the second joint portion 332 joined to the first terminal 140A, and a third joint portion 333a joined to the second terminal 140B. The first joint portion 331 and the second joint portion 332 are separated in the X-axis direction. The third joint portion 333a is in the central portion of the bus bar 300 in the X-axis direction. These configurations are the same as those of the energy storage apparatus 1 according to the above example embodiments.

In the present modification example, the third joint portion 333a includes a fourth joint portion 334 and a fifth joint portion 335, and the fourth joint portion 334 and the fifth joint portion 335 are separated in the X-axis direction.

As described above, in the present modification example, the second terminal 140B and the bus bar 300 are joined at two places of the fourth joint portion 334 and the fifth joint portion 335 disposed separately in the X-axis direction. Thus, the length of a conductive path connecting the first joint portion 331 and the third joint portion 333a and the length of a conductive path connecting the second joint portion 332 and the third joint portion 333a can be made substantially the same, and the length can be made relatively short. This is advantageous, for example, for improving the conduction efficiency between the first energy storage device 100A and the second energy storage device 100B. Of the fourth joint portion 334 and the fifth joint portion 335 in the present modification example, the fourth joint portion 334 is closer to the first joint portion 331 than the fifth joint portion 335. Of the fourth joint portion 334 and the fifth joint portion 335, the fifth joint portion 335 is closer to the second joint portion 332 than the fourth joint portion 334. Therefore, the length of the conductive path connecting the first joint portion 331 and the third joint portion 333a is the length of a conductive path connecting the first joint portion 331 and the fourth joint portion 334. The length of the conductive path connecting the second joint portion 332 and the third joint portion 333a is the length of a conductive path connecting the second joint portion 332 and the fifth joint portion 335.

In the present modification example, since mechanical connecting portions (the fourth joint portion 334 and the fifth joint portion 335) between the bus bar 300 and the second terminal 140B are separated in the X-axis direction, the bus bar 300 can be more stably fixed to the second terminal 140B. Further, it is easy to increase the area of the third joint portion 333a in plan view, that is, to increase the joint area between the bus bar 300 and the second terminal connecting portion 320.

The third joint portion 333a formed in the second terminal connecting portion 320 may further include one or more joint portions joined to the second terminal 140B, for example, between the fourth joint portion 334 and the fifth joint portion 335. That is, the third joint portion 333a may include three or more joint portions disposed separately from each other.

The position, shape, and size of each of the plurality of joint portions provided in the third joint portion 333a may be appropriately determined according to, for example, a joint area, joint strength, or the like between the second terminal connecting portion 320 and the second terminal 140B, which is required for the energy storage apparatus 1a.

Although the energy storage apparatuses 1 and 1a according to the example embodiments and the modification examples of the present invention have been described above, the present invention is not limited to the example embodiments and the modification examples. The example embodiments and the modification examples disclosed herein are illustrative in all respects, and the scope of the present invention includes all changes within the meaning and scope equivalent to the claims.

In the intermediate connecting portion 350 included in the bus bar 300, each of the first intermediate portion 351 and the second intermediate portion 352 may include two portions separated in the X-axis direction, similarly to the third intermediate portion 355. For example, it is assumed that both the first intermediate portion 351 and the second intermediate portion 352 include two portions separated in the X-axis direction. In this case, for example, the first intermediate portion 351, the second intermediate portion 352, and the first terminal connecting portion 310 are formed of two plate-shaped portions extending from both ends in the X-axis direction at the end of the second terminal connecting portion 320 in the Y-axis positive direction. That is, the first joining plate portion 311 and the second joining plate portion 312 included in the first terminal connecting portion 310 may be formed of the tip portions of the two plate-shaped portions extending from the second terminal connecting portion 320. Thus, the amount of a metal material used for the bus bar 300 can be reduced. Alternatively, the bus bar 300 can be reduced in weight.

The first terminal connecting portion 310 included in the bus bar 300 is not necessarily separated in the X-axis direction. That is, the first terminal connecting portion 310 may be a single plate-shaped portion, which is a portion of the bus bar 300 and is not separated in the X-axis direction. In this case, as described above, the first terminal connecting portion 310 includes the recessed portion recessed in the Z-axis positive direction or the through-hole penetrating in the thickness direction (Z-axis direction), whereby the first terminal connecting portion 310 can be joined to the first terminal 140A while avoiding interference with the terminal convex portion 141b (see FIG. 4).

The bus bar 300 may not include the second opening portion 359. For example, it is assumed that a distance in the Z-axis direction between the third intermediate portion 355 of the intermediate connecting portion 350 and the second terminal connecting portion 320 (see FIG. 6) is relatively long. In this case, the second terminal connecting portion 320 may be joined to the second terminal 140B by irradiating the second terminal connecting portion 320 with a laser beam for welding, for example, by allowing the laser light to pass through the side (in the X-axis positive direction or the X-axis negative direction) of the third intermediate portion 355.

The terminal convex portion 141b formed on the first terminal 140A may not be formed by the end of the shaft portion included in the first terminal 140A. For example, a portion of the terminal body 141a, which projects from the upper surface of the terminal body 141a, may be the terminal convex portion 141b.

The bus bar unit 400 may not include the bus bar holder 401. For example, the spacer 200 (see FIG. 2) disposed along the long side surface 111 (see FIG. 3) of the energy storage device 100 may include a portion that holds the bus bar 300. The bus bar unit 400 may not include the wiring board 500. For example, a sheathed cable for voltage detection may be electrically connected to each of the plurality of bus bars 300. That is, the voltages of the plurality of energy storage devices 100 may be detected via a plurality of sheathed cables.

The energy storage apparatus 1 may not include the case 600. For example, a structure including the energy storage device 100, the spacer 200, the bus bar 300, and the bus bar holder 401 may be accommodated as the energy storage apparatus 1 in any device, a rack, or the like.

Example embodiments constructed by arbitrarily combining the components, features, etc., included in the above example embodiments and the modification examples thereof are also included in the scope of the present invention.

Example embodiments of the present invention can be applied to energy storage apparatuses or the like including energy storage devices such as lithium ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a first energy storage device;
a second energy storage device; and
a bus bar; wherein
the first energy storage device and the second energy storage device are arranged side by side in a first direction;
the first energy storage device includes a first terminal arranged in a second direction intersecting the first direction;
the second energy storage device includes a second terminal arranged in the second direction;
the bus bar includes:
a first joint portion and a second joint portion joined to the first terminal; and
a third joint portion joined to the second terminal;
the first joint portion and the second joint portion are separated in a third direction intersecting the first direction and the second direction; and
the third joint portion is in a central portion of the bus bar in the third direction.

2. The energy storage apparatus according to claim 1, wherein
the bus bar includes a first opening portion; and
the first opening portion is between the first joint portion and the second joint portion in the third direction.

3. The energy storage apparatus according to claim 2, wherein the bus bar includes:
a first joining plate portion including the first joint portion; and
a second joining plate including the second joint portion, the second joining plate portion being separated from the first joining plate portion in the third direction; and
the first opening portion is a gap between the first joining plate portion and the second joining plate portion.

4. The energy storage apparatus according to claim 1, wherein at least a portion of the third joint portion is aligned with a region between the first joint portion and the second joint portion in the first direction when viewed in the second direction.

5. The energy storage apparatus according to claim 1, wherein the bus bar includes:
a first terminal connecting portion including the first joint portion and the second joint portion;
a second terminal connecting portion including the third joint portion; and
an intermediate connecting portion that connects the first terminal connecting portion and the second terminal connecting portion;
the first terminal connecting portion is located on one side of the second terminal connecting portion in the first direction; and
the intermediate connecting portion is connected to an end of the first terminal connecting portion on the other side in the first direction and connected to an end of the second terminal connecting portion on the other side in the first direction.

6. The energy storage apparatus according to claim 5, wherein the intermediate connecting portion includes a second opening portion at a position facing the third joint portion in the second direction.

7. The energy storage apparatus according to claim 1, wherein the third joint portion includes a fourth joint portion and a fifth joint portion separated in the third direction.
